(19) United States
(12) Patent Application Publication
(10) Pub. No.: US 2005/0007490 A1
(43) Pub. Date: Jan. 13, 2005

(54) Scaling by early deinterlacing

(76) Inventors: Alexander G. MacInnis, Los Altos, CA (US); Greg Alan Kranawetter, Saratoga, CA (US); Sandeep Bhatia, Bangalore (IN); Shen-Yung Chen, Fremont, CA (US); Mahadhevan Sivagururaman, Tirupur (IN); D. Srilakshmi, Bangalore (IN)

Correspondence Address: MCANDREWS HELD & MALLOY, LTD, 500 WEST MADISON STREET, SUITE 3400, CHICAGO, IL, 60661, US

(21) Appl. No.: 10/611,451

(22) Filed: Jun. 30, 2003

(51) Int. Cl. H04N 11/20

(52) U.S. Cl. 348/448; 348/581

(57) ABSTRACT

Presented herein are a system, method, and apparatus for improving scaling with early deinterlacing. Interlaced frames are deinterlaced prior to scaling. Accordingly, the scaler scales an entire frame, in contrast to individual fields, thereby resulting in an improved scaling function.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

A video comprises a series of frames. The frames are individual images of the video at a particular time period. Frames comprise a two-dimensional grid of pixels, where each pixel contains a value that describes a small location of the video during the time period of the frame.

Each of the pixels value can be captured either simultaneously or at one of two different times. A progressive frame is a frame where all of the pixels are captured simultaneously. Motion picture movies usually use progressive frames. An interlaced frame is a frame where pixels in even-numbered lines are captured at one time, while the pixels in odd-numbered lines are captured at another time. The collection of the pixels in the even-numbered lines are known as the top field, while the collection of the pixels in the odd-numbered lines is known as the bottom field. Many of the broadcast television standards, such as the National Television Standards Committee (NTSC) standard and Phase Alternate Lining (PAL) use interlaced frames. Interlaced frames include fields that are captured at two different times.

A progressive display unit displays all of the lines of a frame in top to bottom order. An interlaced display unit displays the even-numbered lines from top to bottom, and then the odd-numbered lines from top to bottom. Although initially, interlaced display units were more popular, progressive units are becoming more and more common. Most computer monitors are progressive display units. Additionally, many television sets are capable of both interlaced and progressive displaying because more of the content displayed on televisions screens include progressive frames. For example, most motion pictures on Digital Versatile Discs (DVDs) include progressive frames. Additionally, many of the proposed high-definition television standards (HDTV) involve both progressive and interlaced displaying.

When a video that includes interlaced frames is displayed on a progressive display unit, a deinterlacer is used to create a progressive frame from the top field and the bottom field of the frame. There are a number of ways to deinterlace interlaced frames. For example, in a simple scheme, the top field and the bottom field are simply combined. Other solutions involve processing and analyzing the video signal in both the spatial and temporal domains.

Compression standards, such as MPEG-2, exist that compress both videos with interlaced frames and videos with progressive frames. The compressed video is encoded and transmitted to a decoder. During the decoding process, the decoder recovers the original frames. After recovering the original frames, a display engine receives the frames. The display engine performs various functions such as scaling the frames for display on the display unit. In conventional system, the deinterlacer deinterlaces interlaced frames after scaling, and very close to the presentation time on the display unit.

Deinterlacing interlaced frames close to the presentation time is disadvantageous for a number of reasons. Because the interlaced frames are scaled before deinterlacing, the scaler individually scales each field of the interlaced frames, without regard for the additional video data in the other field of the interlaced frame. Additionally, deinterlacing interlaced frames involves considerable real-time processing.

Further limitations and disadvantages of conventional and traditional approaches will become apparent to one of skill in the art, through comparison of such systems with embodiments of the present invention as set forth in the remainder of the present application with reference to the drawings.

### BRIEF SUMMARY OF THE INVENTION

Described herein are a system, method, and apparatus for improved scaling by early deinterlacing. In one embodiment, there is presented a method comprising deinterlacing an interlaced frame, thereby resulting in a deinterlaced frame, and scaling the deinterlaced frame.

In another embodiment, there is presented a system for presenting interlaced frames. The system includes a video decoder, a deinterlacer, and a display engine. The video decoder decodes the interlaced frames. The deinterlacer deinterlaces the interlaced frames, thereby resulting in deinterlaced frames. The display engine scales the deinterlaced frames.

In another embodiment, there is presented a system for decoding interlaced frames. The system includes a video decoder and a display engine. The video decoder further includes a deinterlacer. The decoder decodes interlaced frames. The deinterlacer deinterlaces the interlaced frames resulting in deinterlaced frames. The display engine scales the deinterlaced frames.

In another embodiment, there is presented a system for decoding interlaced frames. The system includes a video decoder and a display engine. The display engine further includes a deinterlacer. The decoder decodes interlaced frames. The deinterlacer deinterlaces the interlaced frames resulting in deinterlaced frames. The display engine scales the deinterlaced frames.

In another embodiment, there is presented a circuit for presenting interlaced frames. The circuit includes a processor and a memory connected to the processor. The memory stores a plurality of instructions executable by the processor. Execution of the plurality of instructions by the processor causes receiving interlaced frames, deinterlacing the interlaced frames, and scaling the deinterlaced frames.

In another embodiment, there is presented a decoder for decoding interlaced frames. The decoder comprises a decompression engine and a deinterlacer. The decompression engine decompresses the interlaced frames. The deinterlacer deinterlaces the interlaced frames.

In another embodiment, there is presented a display engine for scaling interlace frames. The display engine comprises a deinterlacer and a scaler. The deinterlacer deinterlaces the interlaced frames, thereby resulting in deinterlaced frames. The scaler scales the deinterlaced frames.

These and other advantages and novel features of the present invention, as well as details of an illustrated embodiment thereof, will be more fully understood from the following description and drawing.

### BRIEF DESCRIPTION OF SEVERAL VIEWS OF THE DRAWINGS

FIG. 1 is a block diagram describing an exemplary encoding process of a video comprising interlaced frames;

FIG. 2 is a block diagram of an exemplary decoder system in accordance with an embodiment of the present invention;

FIG. 3 is a flow diagram for presenting interlaced frames in accordance with an embodiment of the present invention;

FIG. 4 is a block diagram describing the MPEG-2 encoding process;

FIG. 5 is a block diagram of an exemplary decoder system in accordance with an embodiment of the present invention;

FIG. 6 is a block diagram of an exemplary decoder in accordance with an embodiment of the present invention; and

FIG. 7 is a block diagram of an exemplary display engine in accordance with an embodiment of the present invention.

### DETAILED DESCRIPTION OF THE INVENTION

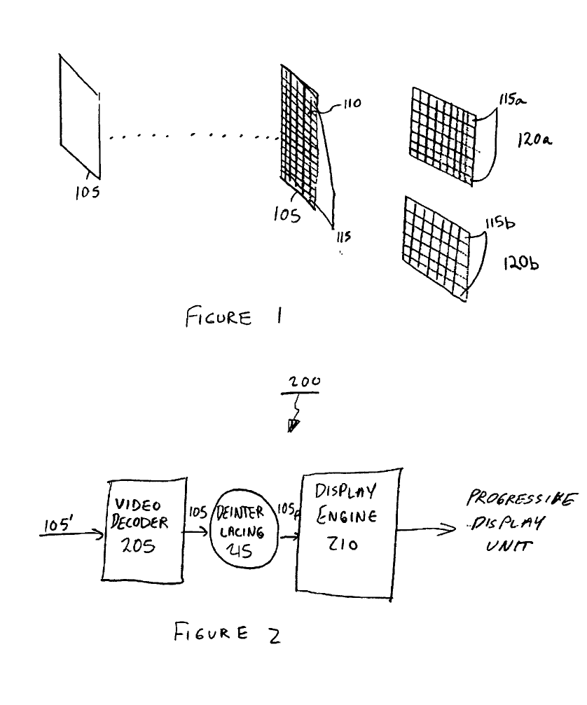

Referring now to FIG. 1, there is illustrated a block diagram describing an exemplary encoding process. A video 100 comprises a series of successive frames 105. The frames comprise two-dimensional grids of pixels 110, wherein each pixel 110 in the grid corresponds to a particular spatial location of an image captured by the camera. Each pixel 110 stores a color value describing the spatial location corresponding thereto. Accordingly, each pixel 110 is associated with two spatial parameters (x,y) as well as a time parameter associated with the frame.

The pixels 110 are scanned by a video camera. A progressive camera scans each row 115 of a frame 105 simultaneously. In contrast, an interlaced camera scans the even rows 115a at a first time instant, and the odd rows 115b at a second time instant. The even rows 115a form a two dimensional grid of pixels 110 with half as many lines as the frame, known as the top field 120a. Similarly, the odd rows 115b form a grid known as the bottom field 120b. An interlaced frame 105 comprises the top field 120a followed by the bottom field 120b.

An exemplary video 100 can include 30 frames 105, each frame 105 comprising 480 rows of 720 pixels. The foregoing results in a display rate of approximately 165 Mbps. The bandwidth and memory requirements for the transport and storage of an uncompressed video are extremely high. Accordingly, the frames 105 can be compressed and encoded in accordance with a compression standard. The compressed frames 105′ form a portion of the compressed video 100′.

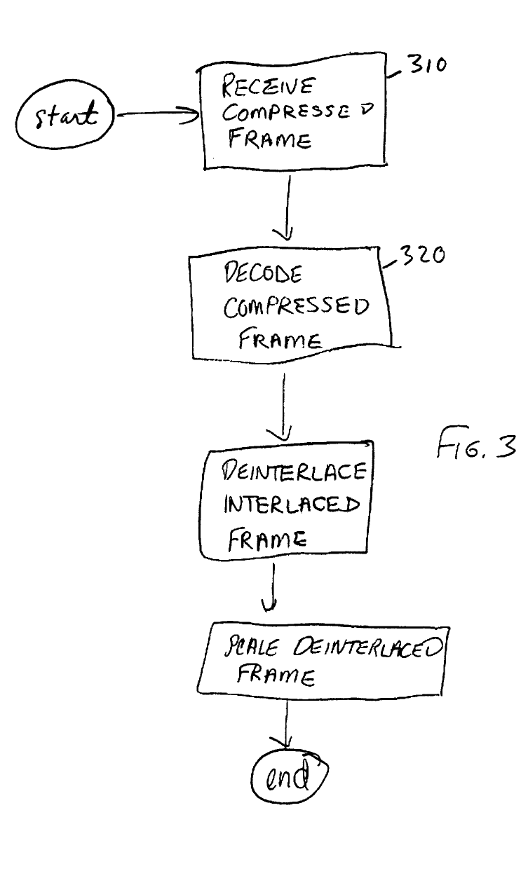

Referring now to FIG. 2, there is illustrated a block diagram describing an exemplary decoder system 200 in accordance with an embodiment of the present invention. The decoder system 200 includes a video decoder 205, a display engine 210 and a deinterlacer 215. The video decoder 205 receives the compressed video 100′ and decompresses the compressed frames 105′. The display engine 210 scales the frames 105 for display on a progressive display unit. The scaling includes resizing the frame 105 for the display area on the progressive display unit.

A decoded interlaced frame 105 includes a top field 120a followed by a bottom field 120b. In order to display interlaced frames 105 on a progressive display unit, the decoder system 200 deinterlaces the interlaced frames 105. Deinterlacing of the interlaced frames 105 involves creating a deinterlaced frame 105p from the top field 120a and the bottom field 120b. For example, the deinterlaced frame 105p can comprise a frame where the even rows are from the top field 120a and the odd rows are from the bottom field 120b.

In order to improve scaling of the frames 105, the interlaced frames 105 are deinterlaced prior to scaling by the display engine 210. By deinterlacing interlaced frames 105 prior to scaling, the display engine 210 scales the deinterlaced frame 105p, in constrast to scaling the top field 120a and the bottom field 120b.

The deinterlacer 215 receives the decoded interlaced frames 105 from the video decoder 205 and deinterlaces the interlaced frames 105, resulting in a deinterlaced frame 105p. The deinterlacer 215 provides the progressive frames 105p to the display engine 210. Although the deinterlacer 215 is shown separately, it should be noted that the deinterlacer 215 can be integrated or incorporated into either the video decoder 205 or the display engine 210. Where the deinterlacer 215 is integrated or incorporated into the video decoder 205, the deinterlacer is positioned after the video decoding and decompressing functions. Where the deinterlacer 215 is integrated or incorporated into the display engine 210, the deinterlacer 215 is positioned to receive the decoded frames 105 prior to the scaling functions of the display engine 210.

In one embodiment, scaling the deinterlaced frame 105p is preferable to scaling the top field 120a and the bottom field 120b. Scaling the top field 120a individually is without regard to the content of the bottom field 120b, and vice versa. By scaling the deinterlaced frame 105p, the scaling is on the basis of the information contained in, or at least some function thereof, both the top field 120a and the bottom field 120b.

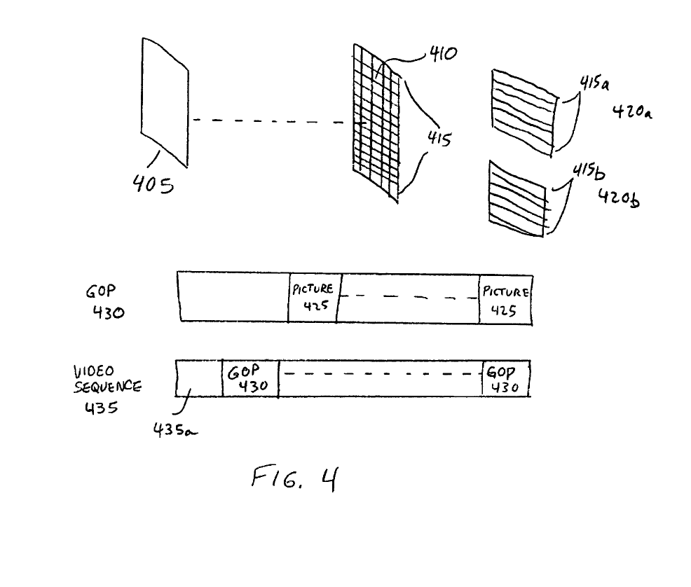

Referring now to FIG. 3, there is illustrated a flow diagram for presenting compressed interlaced frames for display in accordance with an embodiment of the present invention. At 310, a compressed frame 105′ is received and decoded at 320, thereby recovering the interlaced frame 105. At 330, the interlaced frame is deinterlaced, resulting in a deinterlaced frame 105p. At 340, the deinterlaced frame 105p is scaled.

The foregoing is versatile and adaptable to a variety of formatting and compression standards, where interlaced frames 105 are displayed on a progressive display unit. For example, the MPEG-2 standard is used to compress videos with interlaced frames as well as videos with progressive frames.

Referring now to FIG. 4, there is illustrated a block diagram describing the MPEG-2 encoding process. A video 400 comprises a series of successive frames 405. The frames comprise two-dimensional grids of pixels 410, wherein each pixel 410 in the grid corresponds to a particular spatial location of an image captured by the camera. Each pixel 410 stores a color value describing the spatial location corresponding thereto. Accordingly, each pixel 410 is associated with two spatial parameters (x,y) as well as a time parameter associated with the frame.

The pixels 410 are scanned by a video camera. A progressive camera scans each row 415 of a frame 405 simultaneously. In contrast, an interlaced camera scans the even rows 415a at a first time instant, and the odd rows 415b at a second time instant. The even rows 415a form a two dimensional grid of pixels 410 with half as many lines as the frame, known as the top field 420a. Similarly, the odd rows 415b form a grid known as the bottom field 420b. An interlaced frame 405 comprises the top field 420a followed by the bottom field 420b.

The MPEG-2 standard uses a variety of algorithms that take advantage of both spatial and temporal redundancies to compress the frames 405 in a data structure known as a picture 425. The pictures 425 are grouped into another structure known as a group of pictures 430. The video 400 is represented by a video sequence 435 that includes a header 435a, and any number of groups of pictures 430.

The video sequence 435 is packetized and can be multiplexed with any number of other video sequences 435 into a transport stream for transmission over a communication medium. The transport stream is received at a decoder system that decodes the video sequence 435 to recover the video 400.

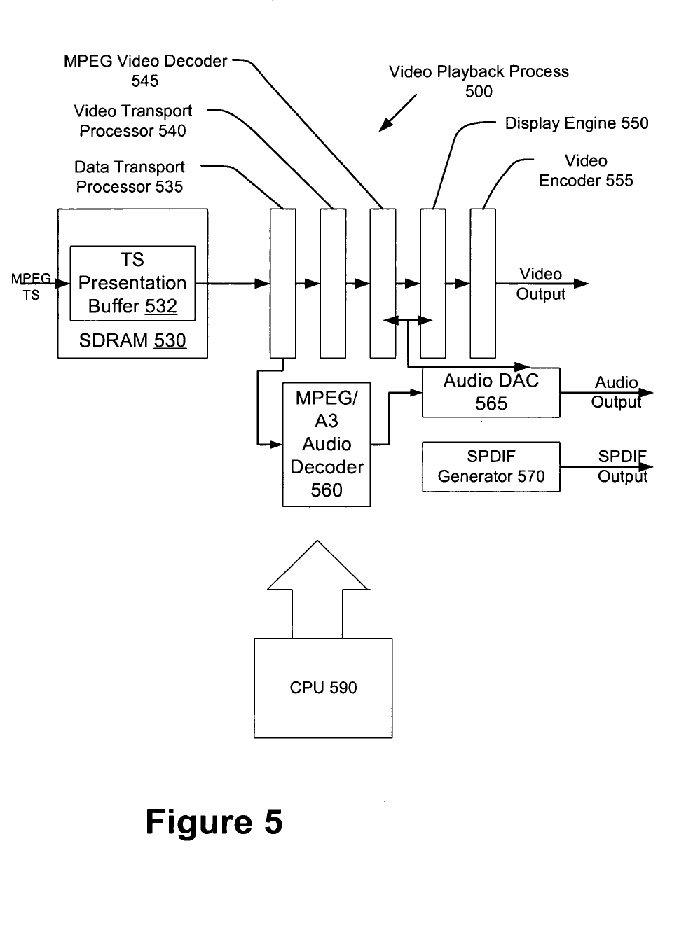

Referring now to FIG. 5, there is illustrated a block diagram of an exemplary decoder in accordance with an embodiment of the present invention. Data is output from buffer 532 within SDRAM 530. The data output from the presentation buffer 532 is then passed to a data transport processor 535. The data transport processor 535 demultiplexes the transport stream into packetized elementary stream constituents, and passes the audio transport stream to an audio decoder 560 and the video transport stream to a video transport decoder 540 and then to a MPEG video decoder 545. The audio data is then sent to the output blocks, and the video is sent to a display engine 550. The display engine 550 scales the video picture, renders the graphics, and constructs the complete display. Once the display is ready to be presented, it is passed to a video encoder 555 where it is converted to analog video using an internal digital to analog converter (DAC). The digital audio is converted to analog in an audio digital to analog (DAC) 565.

A decoded interlaced frame 405 includes a top field 420a followed by a bottom field 420b. In order to display interlaced frames 405 on a progressive display unit, the decoder system 500 deinterlaces the interlaced frames 405. Deinterlacing of the interlace frames 405 involves creating a deinterlaced frame 405p from the top field 420a and the bottom field 420b. For example, the deinterlaced frame 405p can comprise a frame where the even rows are from the top field 420a and the odd rows are from the bottom field 420b.

In order to improve scaling of the frames 405, the interlaced frames 405 are deinterlaced prior to scaling by the display engine 550. By deinterlacing interlaced frames 405 prior to scaling, the display engine 550 scales the deinterlaced frame 405p, in constrast to scaling the top field 420a and the bottom field 420b.

In one embodiment, scaling the deinterlaced frame 105p is preferable to scaling the top field 120a and the bottom field 120b. Scaling the top field 120a individually is without regard to the content of the bottom field 120b, and vice versa. By scaling the deinterlaced frame 105p, the scaling is on the basis of the information contained in, or at least some function thereof, both the top field 120a and the bottom field 120b.

The deinterlacing can be integrated or incorporated into either the video decoder 545 or the display engine 550. Where the deinterlacing is integrated or incorporated into the video decoder 545, the deinterlacer is positioned after the video decompressing functions. Where the deinterlacing is integrated or incorporated into the display engine 550, the deinterlacer is positioned to receive the decoded frames 405 prior to the scaling functions of the display engine 550.

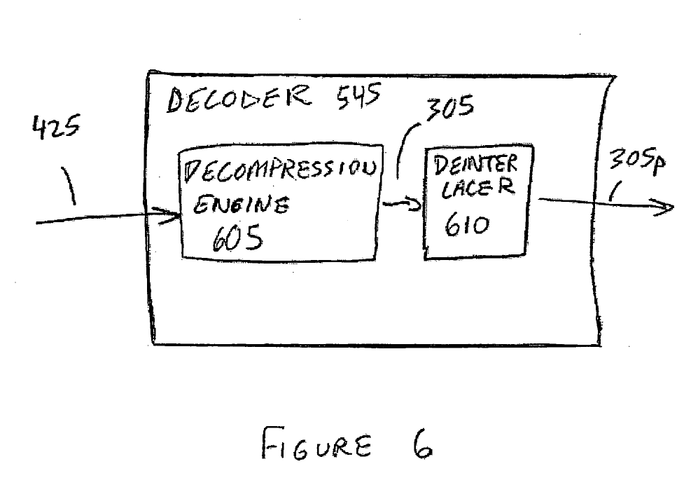

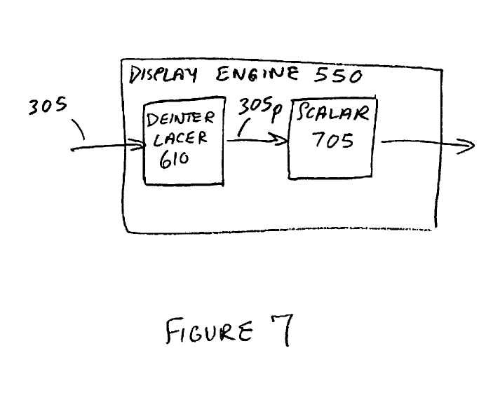

Referring now to FIG. 6, there is illustrated a block diagram of an exemplary video decoder 545 in accordance with an embodiment of the present invention. The decoder 545 comprises a decompression engine 605 and a deinterlacer 610. The decompression engine 405 receives and decompresses pictures 425, resulting in interlaced frames 405. The interlaced frames 405 comprise a top field 420a and a bottom field 420b. The deinterlacer 510 receives the interlaced frame 405, and deinterlaces the frame 405, resulting in a deinterlaced frame 405p. The deinterlaced frame 405p is provided for later scaling.

Referring now to FIG. 7, there is illustrated a block diagram describing the display engine 550 in accordance with an embodiment of the present invention. The display engine 550 comprises a deinterlacer 610 and a scaler 705. The deinterlacer 610 receives decompressed interlaced frames 405 prior to scaling and deinterlaces the frames resulting in progressive frames 405p. The deinterlaced frames 405p are provided to the scaler 605. The scaler 605 scales the deinterlaced frames 405p.

The decoder system as described herein may be implemented as a board level product, as a single chip, application specific integrated circuit (ASIC), or with varying levels of the decoder system integrated with other portions of the system as separate components. The degree of integration of the decoder system will primarily be determined by the speed and cost considerations. Because of the sophisticated nature of modern processor, it is possible to utilize a commercially available processor, which may be implemented external to an ASIC implementation. Alternatively, if the processor is available as an ASIC core or logic block, then the commercially available processor can be implemented as part of an ASIC device wherein various operations are implemented in firmware.

While the invention has been described with reference to certain embodiments, it will be understood by those skilled in the art that various changes may be made and equivalents may be substituted without departing from the scope of the invention. In addition, many modifications may be made to adapt particular situation or material to the teachings of the invention without departing from its scope. Therefore, it is intended that the invention not be limited to the particular embodiment(s) disclosed, but that the invention will include all embodiments falling within the scope of the appended claims.

1. A method for presenting an interlaced frame, said method comprising:
deinterlacing the interlaced frame, thereby resulting in a deinterlaced frame; and
scaling the deinterlaced frame.

2. The method of claim 1, further comprising:
decoding the interlaced frame.

3. The method of claim 2, wherein decoding the frame further comprises:
decompressing the frame, thereby resulting in the interlaced frame.

4. A system for presenting interlaced frames, said system comprising:
a video decoder for decoding interlaced frames;
a deinterlacer for deinterlacing the interlaced frames, thereby resulting in deinterlaced frames; and
a display engine for scaling the deinterlaced frames.

5. The system of claim 4, wherein the video decoder further comprises:
a decompression engine for decompressing the interlaced frames.

6. The system of claim 5, wherein the video decoder comprises:
an MPEG-2 video decoder for decompressing the interlaced frames.

7. A system for presenting interlaced frames, said system comprising:
a video decoder for decoding interlaced frames, the decoder further comprising a deinterlacer for deinterlacing the interlaced frames, thereby resulting in deinterlaced frames; and
a display engine for scaling the deinterlaced frames.

8. The system of claim 7 wherein the decoder further comprises:
a decompression engine for decompressing the interlaced frames.

9. A system for presenting interlaced frames, said system comprising:
a video decoder for decoding interlaced frames;
a display engine for scaling deinterlaced frames, wherein the display engine further comprises a deinterlacer for deinterlacing the interlaced frames, thereby resulting in the deinterlaced frames.

10. The system of claim 9, wherein the display engine further comprises a scaler for scaling the deinterlaced frames.

11. A circuit for presenting interlaced frames, said circuit comprising:
a processor; and
a memory connected to the processor, said memory storing a plurality of instructions executable by the processor, wherein execution of the plurality of instructions by the processor cause:
receiving interlaced frames;
deinterlacing the interlaced frames; and
scaling the deinterlaced frames.

12. The circuit of claim 11, wherein execution of the plurality of instructions by the processor further causes:
decoding the interlaced frames.

13. The circuit of claim 11, wherein execution of the plurality of instructions by the processor further causes:
decompressing the interlaced frames.

14. A decoder for decoding interlaced frames, said decoder comprising:
a decompression engine for decompressing the interlaced frames; and
a deinterlacer for deinterlacing the interlaced frames.

15. A display engine for scaling interlace frames, said display engine comprising:
a deinterlacer for deinterlacing the interlaced frames, thereby resulting in deinterlaced frames; and
a scaler for scaling the deinterlaced frames.
